(19) United States
(12) Patent Application Publication
(10) Pub. No.: US 2015/0271431 A1
(43) Pub. Date: Sep. 24, 2015

(54) Information Transmission Method and Wireless Display System

(71) Applicant: Wistron Corporation, New Taipei City (TW)

(72) Inventors: Pen-Tai Miao, New Taipei City (TW); Ping-Hung Chen, New Taipei City (TW)

(21) Appl. No.: 14/300,242

(22) Filed: Jun. 10, 2014

(30) Foreign Application Priority Data
Mar. 20, 2014 (TW) 103110566

(51) Int. Cl. H04N 5/38; H04N 5/93

(52) U.S. Cl. CPC H04N 5/38; H04N 5/93

(57) ABSTRACT

An information transmission method is utilized in a wireless display system and the wireless display system includes a source terminal and a sink terminal establishing a wireless connection with each other. The information transmission method includes the sink terminal receiving and displaying frame information transmitted from the source terminal by a data channel and obtaining an operation information; the sink terminal generating a control information according to the operation information and transmitting the control information to the source terminal by a user input back channel; the source terminal performing a command in the control information to output a result information; and the source terminal determining whether to adjust the result information to a display information with a smaller amount of information according to a transmission setting corresponding to the command in the control information and transmitting the display information to the sink terminal by the data channel.

### BACKGROUND OF THE INVENTION

1. Field of the Invention

The present invention relates to an information transmission method and a wireless display system, and more particularly, to an information transmission method and a wireless display system capable of remotely operating a source terminal from a sink terminal through a user input back channel and instantly displaying video frames generated from operations at the source terminal.

2. Description of the Prior Art

Wi-Fi Direct based wireless display standards such as Miracast™ allow a source terminal to share video frames with a sink terminal through wireless connections. For examples, a mobile phone (source terminal) supporting the wireless display standard may transmit video frames to a television (sink terminal) supporting the wireless display standard through an established wireless connection, such that the video frames are displayed on the television. The sink terminal passively receives and displays the video frames from the source terminal, in addition, the sink terminal may receive an operation information inputted by a user, and transmit the operation information to the source terminal through a user input back channel (UIBC) defined in the wireless display standard, such that the user may use the sink terminal to remotely operate the source terminal, and the source terminal transmits video frames generated by the operations at the source terminal to the sink terminal for displaying the frames.

In such a situation, the source terminal needs to receive the operation information through the user input back channel and execute a command stored in the operation information. After executing the command, the source terminal further needs to transmit the resulting video frames to the sink terminal through the wireless connection. However, when the operational capability of the source terminal is insufficient, the source terminal may not have capability to perform execution of command and transmission of video frames simultaneously, such that the sink terminal may not receive video frames instantly, and a severe video frame delay happens, which degrades a smoothness felt by the user. Therefore, how to remotely operate the source terminal from the sink terminal through the UIBC and instantly display the video frames, generated from the operations at the source terminal, on the sink terminal is a significant objective in the field.

### SUMMARY OF THE INVENTION

It is therefore a primary objective of the present invention to provide an information transmission method and a wireless display system, which allows the sink terminal to operate the source terminal through the user input back channel and instantly display the video frames generated from the operations at the source terminal.

An embodiment of the invention discloses an information transmission method, utilized in a wireless display system comprising a source terminal and a sink terminal with a wireless connection established. The information transmission method comprises the sink terminal receiving and displaying frame information transmitted from the source terminal through a data channel of the wireless connection, and obtaining an operation information; the sink terminal generating a control information according to the operation information, and transmitting the control information to the source terminal through a user input back channel (UIBC); the source terminal executing a command stored in the control information to generate a result information; and the source terminal determining whether to adjust the result information to be display information with a smaller amount of information according to a transmission setting corresponding to the command in the control information, and transmitting the display information through the data channel to the sink terminal.

An embodiment of the invention further discloses a wireless display system, comprising a source terminal; and a sink terminal, for establishing a wireless connection with the source terminal, receiving and displaying frame information transmitted from the source terminal through a data channel of the wireless connection, and obtaining an operation information, and transmitting the control information to the source terminal through a user input back channel (UIBC); wherein the source terminal is utilized for executing a command stored in the control information to generate a result information, determining whether to adjust the result information to be display information with a smaller amount display information, according to a transmission setting corresponding to the command in the control information, and transmitting the display information through the data channel to the sink terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless display system according to an embodiment of the invention.

FIG. 2 is a schematic diagram of an information transmission process according to an embodiment of the invention.

FIGS. 3A-3D are schematic diagrams illustrating information transmission between a source terminal and a sink terminal according to an embodiment of the invention.

### DETAILED DESCRIPTION

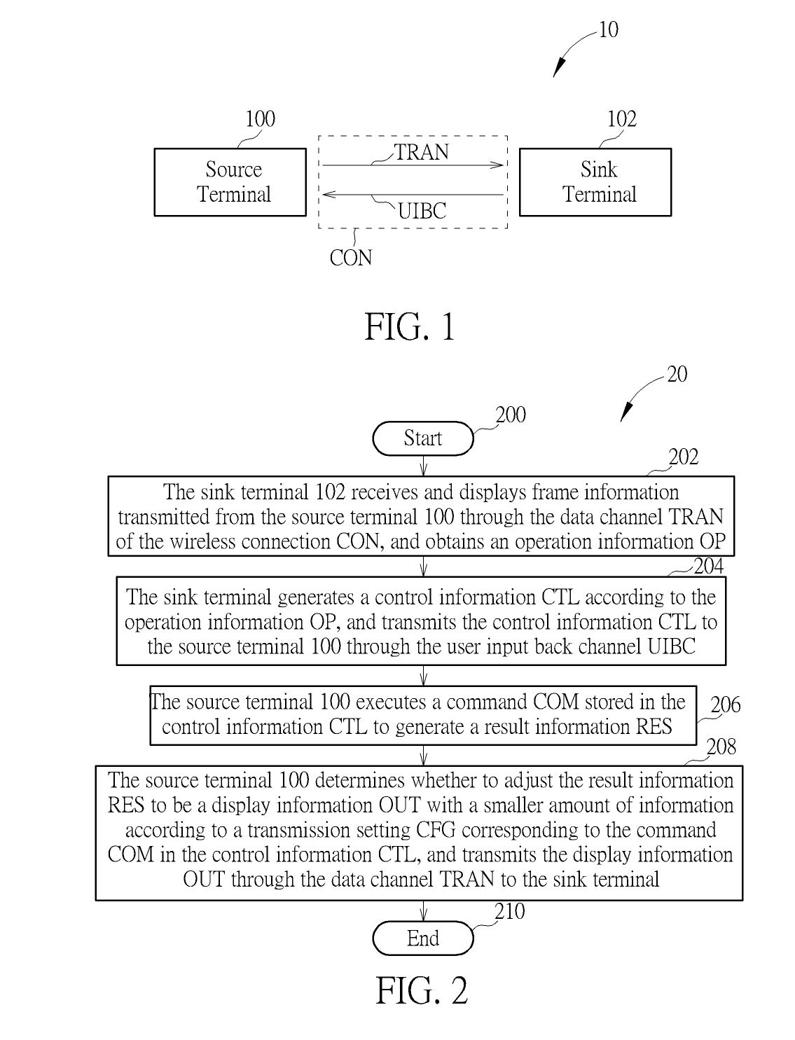

Please refer to FIG. 1. FIG. 1 is a schematic diagram of a wireless display system 10 according to an embodiment of the invention. As shown in FIG. 1, the wireless display system 10 comprises a source terminal 100 and a sink terminal 102. The source terminal 100 and the sink terminal 102 share video frames with each other through an established wireless connection CON according to the Wi-Fi Direct based wireless display standard Miracast™. The source terminal 100 transmits frame information to the sink terminal 102 through a data channel TRAN of the wireless connection CON, and the sink terminal 102 synchronously receives and displays the frame information displayed on the source terminal 100. Moreover, after the sink terminal 102 obtains an operation information inputted by a user, the sink terminal 102 transmits the operation information to the source terminal 100 through a user input back channel UIBC of the wireless connection CON, such that the user may remotely operate the source terminal 100 from the sink terminal 102, and the frame information generated from the operations at the source terminal 100 is displayed on the sink terminal 102. The source terminal 100 and the sink terminal 102 may be electronic devices such as computers, smart televisions, smart phones, tablets, etc., and may be implemented by application-specific integrated circuits (ASIC), or by a processor and a storage device storing program code, and not limited herein. The storage device may be read-only memory (ROM), random-access memory (RAM), CD-ROMs, magnetic tapes, floppy disks, optical data storage devices, etc., and are not limited herein.

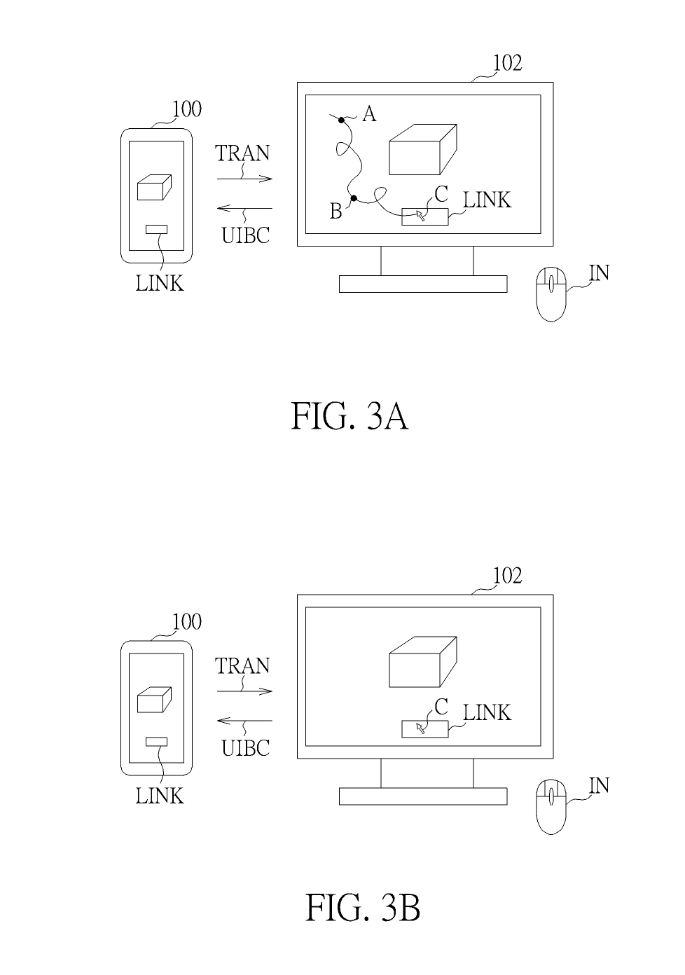

In detail, please refer to FIG. 2. FIG. 2 is a schematic diagram of an information transmission process 20 according to an embodiment of the invention. The information transmission process 20 comprises the following steps:

Step 200: Start.

Step 202: The sink terminal 102 receives and displays frame information transmitted from the source terminal 100 through the data channel TRAN of the wireless connection CON, and obtains an operation information OP.

Step 204: The sink terminal generates a control information CTL according to the operation information OP, and transmits the control information CTL to the source terminal 100 through the user input back channel UIBC.

Step 206: The source terminal 100 executes a command COM stored in the control information CTL to generate a result information RES.

Step 208: The source terminal 100 determines whether to adjust the result information RES to be a display information OUT with a smaller amount of information according to a transmission setting CFG corresponding to the command COM in the control information CTL, and transmits the display information OUT through the data channel TRAN to the sink terminal.

Step 210: End.

According to the information transmission process 20, the present invention analyzes the operation information OP inputted by the user at the sink terminal 102, filters out redundant contents of the operation information, leaves the control information CTL with actual control meaning, and transmits the control information CTL to the source terminal 100 through the user input back channel UIBC, such that the source terminal 100 does not have to consume operational resource to execute the operational contents of the operation information OP which would not cause variation in display. Moreover, the sink terminal 102 of the present invention checks whether the command COM needs to be responded instantly along with contents displayed on the source terminal 100, to decide whether to add the corresponding transmission setting CFG into the control information CTL in advance, so as to inform the source terminal 100 whether to adjust the result information RES to be the display information OUT with the smaller amount of information, such that the source terminal 100 may determine whether to adjust the result information RES outputted after executing the command COM to be the display information OUT with the smaller amount of information according to the transmission setting CFG, to allow the source terminal 100 flexibly consuming less operational resource to transmit the display information OUT to the sink terminal 102. Thus, the source terminal 100 may perform execution of the command COM and transmission of the display information OUT simultaneously, such that the sink terminal 102 may instantly present the display information OUT generated by the source terminal 100, avoiding significant frame delay.

Specifically, in Step 202, after the sink terminal 102 receives network packets through the data channel TRAN from the source terminal 100, the sink terminal 102 obtains the frame information transmitted by the source terminal 100 in the network packets, and displays the frame information on a monitor. In addition, after the user sees the frames displayed on the sink terminal 102, the user may perform operations via an input device IN of the sink terminal 102. For example, the user may click at an icon of an application program shown in the displayed frames via a pointing device, select text shown in the displayed frames via the pointing device, key in text via a keyboard, etc., so as to input as the operation information OP. Next, the sink terminal 102 stores the operational contents inputted by the user as the operation information OP. The contents of the operation information OP may be the pointing device moving from a position A to a position B and clicked on a position C, the pointing device clicked at a position A and then moving to a position B, or a text information inputted from the keyboard. Moreover, the input device IN may be a pointing device (e.g. a mouse), a keyboard, or even a touch panel, and not limited herein.

In Step 204, the sink terminal 102 analyzes the operation information OP, filters out the operational contents of the operation information OP which would not cause variation in display for the source terminal 100, and generates the control information CTL with actual control meaning, and transmits the control information CTL to the source terminal 100 through the user input back channel UIBC. For example, when the user operates the sink terminal 102 via the pointing device, the operational contents of the operation information OP may include a click information and a moving information of the pointing device. When the pointing device is just moving but without clicked, the source terminal 100 would not generate a variation in display (i.e., the source terminal 100 only displays the moving pointing icon but the frames do not change). Therefore, the sink terminal 102 determines whether a button of the pointing device is clicked according to the content of the operation information OP, filters out the operational content before the button of the pointing device is clicked, and only generates the control information CTL with actual control meaning.

In detail, when the sink terminal 102 determines that the button is clicked, the sink terminal 102 further determines whether the button of the pointing device is continuously clicked according to the operation information OP. When the sink terminal 102 determines that the button the pointing device is not continuously clicked, the sink terminal 102 generates the content of the control information as a click command COM1, and adds a position coordinate of the pointing device when the button is clicked into the control information OP. Notably, moving position coordinates before and after the button of the pointing device is clicked would be filtered out and would not be added into the control information CTL, such that the source terminal 100 would not execute commands of moving the pointing device. On the other hand, when the sink terminal 102 determines that the button of the pointing device is continuously clicked, the sink terminal generates the content of the control information as a dragging command COM2, and adds the moving position coordinates of the pointing device when the button is continuously clicked into the control information OP, such that the source terminal 100 executes the command of dragging the pointing device according to the moving position coordinates of the pointing device when the button is continuously clicked, and displays corresponding results.

For example, when the content of the operation information OP is the pointing device moving from a position A to a position B, clicked on a position C and no more click, the sink terminal 102 determines the content of the operation information OP as the click command COM1, and filters out the content of the operation information OP which is the pointing device moving from the position A to the position B (since the pointing device moving from a position A to a position B would not cause the frame displayed on the source terminal 100 to change). Finally, the sink terminal 102 only generates the control information CTL to be executing the click command COM1 at the position C, to inform the source terminal 100 to execute the click command COM1 at position C.

In Step 206, after the source terminal 100 receives the control information CTL through the user input back channel UIBC, the source terminal 100 executes the command COM stored in the control information CTL, such as aforementioned the click command COM1 or the dragging command COM2, and outputs the result information RES including display frames brought by executing the command COM.

In Step 208, the source terminal 100 first determines whether the transmission setting CFG corresponding to the command COM in the control information CTL indicates that the command COM needs to be responded instantly on the sink terminal 102 along with the displayed contents on the source terminal 100, in order to determine whether to adjust the result information RES to be display information OUT with the smaller amount of information. When the transmission setting CFG indicates that the command COM needs to be responded instantly, the source terminal 100 reduces a resolution of frames in the result information RES, and outputs the display information OUT with the smaller amount of information, such that the source terminal 100 may flexibly consume less operational resource to process and transmit the display information OUT with the smaller amount of information to the sink terminal 102. Hence, the sink terminal 102 can instantly present the displayed contents generated by the source terminal 100 after executing the command COM.

Notably, the transmission setting CFG is added into the control information CTL by the sink terminal 102 in advance, to inform the source terminal 100 whether to adjust the result information RES to be the display information OUT with the smaller amount of information. The sink terminal 102 may configure the transmission setting CFG as instant response requested or not according to a characteristic of the command COM. For example, when the command COM is the click command COM1, the sink terminal 102 may predict the source terminal 100 will execute the click command and change display frames, and configure the transmission setting CFG as instant response requested to inform the source terminal 100. The way to configure the transmission setting CFG may be modified accordingly but not limited herein.

In addition, after a pre-defined time interval since the source terminal 100 executes the command COM, the source terminal 100 does not need extra operational resource to execute the command COM and is able to perform transmission of the result information RES with a normal amount of information; hence, the source terminal 100 may optionally not transmit the display information OUT with the smaller amount of information to the sink terminal 102, but directly transmit the result information RES to the sink terminal 102 instead, which means that the sink terminal 102 receiving the frame information with the same resolution as the source terminal 100 to actually display the frames of the source terminal 100.

In other words, in the information transmission process 20, the sink terminal 102 filters out the operational contents of the operation information OP which would not cause variation in display for the source terminal 100, and transmits the filtered control information CTL to the source terminal 100 through the user input back channel UIBC, such that the source terminal 100 would not consume operational resource to execute the operational contents of the operation information OP which would not cause variation in display. Moreover, the sink terminal 102 adds the transmission setting CFG into the control information CTL to inform the source terminal 100 to adjust the result information RES to be the display information OUT with the smaller amount of information, such that the source terminal 100 may consume less operational resource to perform transmission of the display information OUT with the smaller amount of information. Therefore, via the information transmission process 20, the source terminal 100 would not have insufficient time to perform execution of command and transmission of video frames simultaneously, such that the sink terminal 102 instantly receives and displays the display information OUT generated from the operations at the source terminal 100, avoiding significant frame delay.

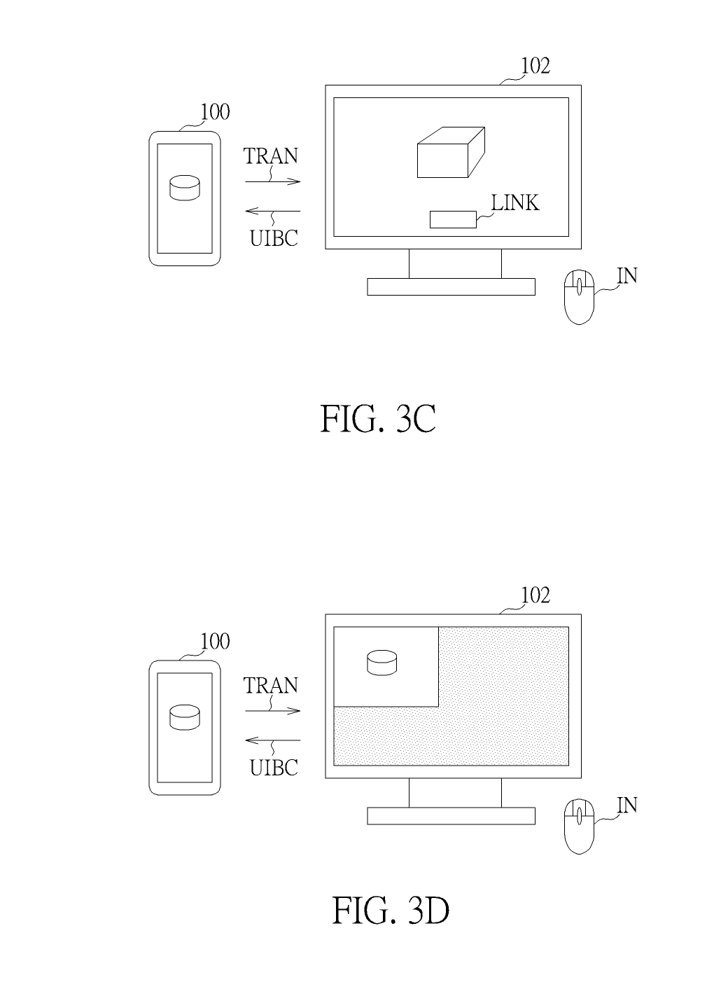

Please refer to FIGS. 3A-3D to realize a practical implementation of the information transmission process 20. FIGS. 3A-3D are schematic diagrams illustrating information transmission between the source terminal 100 and the sink terminal 102 according to an embodiment of the present invention. As shown in FIGS. 3A-3D, the source terminal 100 is a phone device, and the sink terminal 102 is a computer device. The source terminal 100 transmits video frames to the sink terminal 102 through the data channel TRAN to display the video frames on the sink terminal 102. The sink terminal 102 includes the input device IN (which is a mouse) for the user to perform operation, and transmit the operation information to the source terminal 100 through the user input back channel UIBC, so as to remotely operate the source terminal 100.

In detail, through the data channel TRAN, the sink terminal 102 receives the frame information displayed on the source terminal 100, and synchronously displays the same frame displayed on the source terminal 100, which is a web browsing frame including a link icon LINK. In addition, the sink terminal 102 obtains the operation information OP inputted by the user via the input device IN. The content of the operation information OP is a pointer of the input device moving from a position A to a position B and executing a single click at a position C, which means that the user clicks on the link icon LINK of the web browsing frame according to the web browsing frame displayed on the sink terminal 102, in order to browse a website which a link address of the link icon LINK refers to.

In such a situation, in FIG. 3B, the sink terminal 102 analyzes the operation information OP, and filters out the operational content of the operation information OP which would not cause variation in display for the source terminal 100, which means that the filtered operational content is the pointer of the input device IN moving from the position A to the position B. Finally, the sink terminal 102 only generates the control information CTL including the click command COM1 and a coordinate of the position C, and transmits the control information CTL to the source terminal 100 through the user input back channel UIBC. Moreover, the sink terminal 102 further adds the transmission setting CFG with instant response requested into the control information CTL, in order to inform the source terminal 100 to perform operations promptly, so as to instantly display the resulting frame on the sink terminal 102 and respond to the user.

Next, in FIG. 3C, after the source terminal 100 receives the control information CTL through the user input back channel UIBC, the source terminal 100 executes the click command COM1 stored in the control information CTL, which is a click on the link icon LINK, to proceed reading contents of the website which the link address (at the coordinate of the position C) refers to and displaying a new web browsing frame, which is the result information RES. Finally, in FIG. 3D, the source terminal 100 reduces a resolution of the new opened web browsing frame based on the transmission setting CFG in the control information CTL indicating instant response requested, outputs the display information OUT with a lower resolution, and transmits the display information OUT to the sink terminal 102 through the data channel TRAN, such that the sink terminal 102 instantly displays the web browsing frame to respond to the user. Moreover, the sink terminal 102 may display the lower resolution frame in the display information OUT as its original size, as shown in FIG. 3D, or display the frame with an enlarged size by performing an interpolation on the lower resolution frame so as to raise its resolution to be the same as its original resolution. Modifications can be made according to practical requirements and not limited herein.

In this embodiment, the sink terminal 102 filters out the operational contents of the operation information OP which would not cause variation in display for the source terminal 100, and only transmits the control information CTL including the click command COM1 and the coordinate of the position C, therefore, the source terminal 100 would not consume operational resource to execute the operational contents which would not cause variation in display. Furthermore, the sink terminal 102 further adds the transmission setting CFG indicating instant response requested into the control information CTL to inform the source terminal 100 to adjust the result information RES to be the display information OUT with the smaller amount of information, such that the source terminal 100 consumes less operational resource to perform transmission of the display information OUT with the smaller amount of information. In such a situation, the source terminal 100 may perform execution of command and transmission of video frames simultaneously. When the user remotely operates the source terminal 100 from the sink terminal 102 through the user input back channel UIBC, the user can instantly see the display information OUT generated from the operations at the source terminal 100, without a significant frame delay which degrades a smoothness felt by the user.

In short, the information transmission process 20 of the present invention filters out the operational contents of the operation information OP which would not cause variation in display for the source terminal 100, and informs the source terminal 100 to adjust the result information RES to be the display information OUT with the smaller amount of information, such that the source terminal 100 may instantly perform execution of command and transmission of video frames, avoiding significant frame delay. Modifications and alternations can be made accordingly by those skilled in the art. For example, in this embodiment, the sink terminal 102 determines whether the button of the pointing device is clicked, filters out the operational contents before the button is clicked, and only adds the position information when the button of the pointing device is clicked into the control information CTL. However, in another embodiment, the sink terminal 102 may also determine whether an enter key of a keyboard is pressed, filters out the operational contents before the enter key is pressed, only adds the inputted text when the enter key is pressed into the control information CTL, such that the source terminal 100 may consume less operational resource. Methods, which analyze operation information inputted by the user and generate the control information CTL to reduce the operational resource for the source terminal 100, are all applied to the present invention.

In another aspect, in this embodiment, when the transmission setting CFG indicates that the command COM needs to be responded instantly, the source terminal 100 reduces the resolution of the frames in the result information RES, and outputs the display information OUT with the smaller amount of information, such that the source terminal 100 can perform transmission of the display information OUT with the smaller amount of information. However, in another embodiment, when the transmission setting CFG indicates that the command COM needs to be responded instantly, the source terminal 100 may reduce a frame rate of the frame information included in the result information RES, which means that the frame rate of outputting the display information OUT to the sink terminal 102 is reduced, such that the source terminal 100 performs transmission of the display information OUT with the smaller amount of information as well. Modifications and alternations can be made accordingly.

In summary, when the operational capability of the source terminal is insufficient, the source terminal would not have enough time to perform execution of command and transmission of video frames simultaneously, such that a severe video frame delay happens. The information transmission process of the present invention filters the operation information at the sink terminal, and informs the source terminal to transmit the frame information with the smaller amount of information, such that the user may remotely operate the source terminal from the sink terminal through the user input back channel and the generated video frame from the operations at the source terminal is instantly displayed on the sink terminal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information transmission method, utilized in a wireless display system comprising a source terminal and a sink terminal with a wireless connection established, the information transmission method comprising:
the sink terminal receiving and displaying frame information transmitted from the source terminal through a data channel of the wireless connection, and obtaining an operation information;
the sink terminal generating a control information according to the operation information, and transmitting the control information to the source terminal through a user input back channel (UIBC);
the source terminal executing a command stored in the control information to generate a result information; and
the source terminal determining whether to adjust the result information to be display information with a smaller amount of information according to a transmission setting corresponding to the command in the control information, and transmitting the display information through the data channel to the sink terminal.

2. The information transmission method of claim 1, wherein the step of the sink terminal generating the control information according to the operation information comprises:
the sink terminal analyzing the operation information, filtering out redundant contents of the operation information, and generating the control information with control meaning for the source terminal to execute related commands.

3. The information transmission method of claim 1, wherein the operation information is inputted by a user via a pointing device, and the operation information comprises click and moving information of the pointing device.

4. The information transmission method of claim 3, wherein the step of the sink terminal generating the control information according to the operation information comprises:
the sink terminal determining whether a button of the pointing device is clicked according to the operation information;
when the sink terminal determines that the button is clicked, the sink terminal determining whether the button of the pointing device is continuously clicked according to the operation information; and
when the sink terminal determines that the button is not continuously clicked, the sink terminal generating the control information with a click command; or when the sink terminal determines that the button is continuously clicked, the sink terminal generating the control information with a dragging command.

5. The information transmission method of claim 4, wherein the sink terminal further adds position coordinates of the pointing device when the button is clicked into the control information with the click command; or the sink terminal further adds position coordinates of movement of the pointing device when the button is continuously clicked into the control information with the dragging command.

6. The information transmission method of claim 1, wherein the step of the source terminal determining whether to adjust the result information to be the display information with the smaller amount of information according to the transmission setting corresponding to the command in the control information comprises:
the source terminal determining whether the transmission setting indicates that the command needs to be responded instantly; and
when the transmission setting indicates that the command needs to be responded instantly, the source terminal reducing a resolution of frames in the result information, and outputting the display information with the smaller amount of information.

7. The information transmission method of claim 1, wherein the step of the source terminal determining whether to adjust the result information to be the display information with the smaller amount of information according to the transmission setting corresponding to the command in the control information further comprises:
the source terminal determining whether the transmission setting indicates that the command needs to be responded instantly;
when the transmission setting indicates that the command needs to be responded instantly, the source terminal reducing a resolution of frames in the result information, and outputting the display information with the smaller amount of information; and
after a pre-defined time interval since the source terminal executes the command, the source terminal no longer adjusting the result information, and outputting the result information as the display information.

8. The information transmission method of claim 1, wherein the wireless display system transmits the frame information according to a Wi-Fi Direct based wireless display standard.

9. A wireless display system, comprising:
a source terminal; and
a sink terminal, for establishing a wireless connection with the source terminal, receiving and displaying frame information transmitted from the source terminal through a data channel of the wireless connection, and obtaining an operation information, and transmitting the control information to the source terminal through a user input back channel (UIBC);
wherein the source terminal is utilized for executing a command stored in the control information to generate a result information, determining whether to adjust the result information to be display information with a smaller amount display information, according to a transmission setting corresponding to the command in the control information, and transmitting the display information through the data channel to the sink terminal.

10. The wireless display system of claim 9, wherein the sink terminal performs the following step for generating the control information according to the operation information:
analyzing the operation information, filtering out redundant contents of the operation information, and generating the control information with control meaning for the source terminal to execute related commands.

11. The wireless display system of claim 9, wherein the operation information is inputted by a user via a pointing device, and the operation information comprises click and moving information of the pointing device.

12. The wireless display system of claim 11, wherein the sink terminal performs the following steps for generating the control information according to the operation information:
the sink terminal determining whether a button of the pointing device is clicked according to the operation information;
when the sink terminal determines that the button is clicked, the sink terminal further determining whether the button of the pointing device is continuously clicked according to the operation information; and
when the sink terminal determines that the button is not continuously clicked, the sink terminal generating the control information with a click command; or when the sink terminal determines that the button is continuously clicked, the sink terminal generating the control information with a dragging command.

13. The wireless display system of claim 12, wherein the sink terminal further adds position coordinates of the pointing device when the button is clicked into the control information with the click information; or the sink terminal further adds position coordinates of movement of the pointing device during the time which the button is continuously clicked into the control information with the dragging command.

14. The wireless display system of claim 9, wherein the source terminal performs the following steps for determining whether to adjust the result information to be the display information with the smaller amount of information according to the transmission setting corresponding to the command in the control information:
the source terminal determining whether the transmission setting indicates that the command needs to be responded instantly; and
when the transmission setting indicates that the command needs to be responded instantly, the source terminal reducing a resolution of frames in the result information, and outputting the display information with the smaller amount of information.

15. The wireless display system of claim 9, wherein the source terminal performs the following steps for determining whether to adjust the result information to be the display information with the smaller amount of information according to the transmission setting corresponding to the command in the control information:
the source terminal determining whether the transmission setting indicates that the command needs to be responded instantly;
when the transmission setting indicates that the command needs to be responded instantly, the source terminal reducing a resolution of frames in the result information, and outputting the display information with the smaller amount of information; and
after a pre-defined time interval since the source terminal executes the command, the source terminal no longer adjusting the result information, and outputting the result information as the display information.

16. The wireless display system of claim 9, wherein the wireless display system transmits the frame information according to a Wi-Fi Direct based wireless display standard.
